(19) United States
(12) Patent Application Publication
(10) Pub. No.: US 2026/0181297 A1
(43) Pub. Date: Jun. 25, 2026

(54) Speaker

(71) Applicant: AAC Microtech (Changzhou) Co., Ltd., Changzhou City (CN)

(72) Inventors: Huhu Yang, Changzhou (CN); Zhaoyu Yin, Changzhou (CN); Wei Wei, Changzhou (CN); Zhizhu Chen, Changzhou (CN)

(21) Appl. No.: 19/286,228

(22) Filed: Jul. 30, 2025

Related U.S. Application Data
(63) Continuation of application No. PCT/CN2024/141740, filed on Dec. 24, 2024.

(51) Int. Cl. H04R 1/06; H04R 7/12; H04R 7/18; H04R 9/02; H04R 9/06

(52) U.S. Cl. CPC H04R 1/06; H04R 7/127; H04R 7/18; H04R 9/025; H04R 9/06; H04R 2400/11

(57) ABSTRACT

The present application provides a speaker having a frame having an accommodating space, a vibration system accommodated in the frame, and a magnetic circuit system. The vibration system includes a diaphragm and a voice coil. The diaphragm includes a dome having a planar portion perpendicular to a vibration direction and a side surface portion extending from an edge of the planar portion toward the magnetic circuit system. The speaker further comprises a Flexible Printed Circuit (FPC) board electrically connected to the voice coil. The speaker in the application effectively avoids the problem in the related art where the magnetic circuit system occupies less space and thus has a small volume, thereby improving the acoustic performance of the speaker.

### TECHNICAL FIELD

The present application relates to the field of electroacoustic transduction, particularly to a speaker.

### BACKGROUND

A speaker is an electroacoustic transducer capable of converting electrical signals into sound signals and radiating them into the air, playing an indispensable role in audio devices. A speaker typically includes a magnetic circuit system, a vibration system, a frame, and a Flexible Printed Circuit (FPC) board. When the voice coil of the vibration system is energized, it generates an induced magnetic field that interacts with the magnetic field of the magnetic circuit system, producing an upward or downward force that drives the diaphragm of the vibration system to vibrate and push air to produce sound. Currently, consumers'demands for sound quality are increasingly high, and correspondingly, designers'requirements for speaker performance are also increasing.

In the related art, the voice coil of the speaker is mainly connected to external circuits through an FPC board. However, since the solder pad connecting the FPC board to external circuits is fixed on the frame, the flexible arm of the FPC board needs to be bent and extended in a direction perpendicular to the vibration direction into the accommodating space of the frame, which leads to reduced space for the magnetic circuit system and consequently affects the acoustic performance of the speaker.

### SUMMARY

The object of the present application is to provide a speaker with an enlarged magnetic circuit volume for achieving a better acoustic performance.

To achieve the above purposes, the present invention provides a speaker, comprising a frame having an accommodating space; a vibration system accommodated in the frame, including a diaphragm fixed to the frame and a voice coil driving the diaphragm to vibrate and make sound, the diaphragm having a dome located at a middle position and a surround spaced around the dome, the dome including a planar portion perpendicular to a vibration direction and a side surface portion extending from an edge of the planar portion, the frame including a main body having an annular structure and a protrusion portion extending from the main body along the vibration direction and away from the diaphragm; a magnetic circuit system driving the vibration system to vibrate, including a yoke fixed to the frame, a main magnet fixed to the yoke, and an auxiliary magnet spaced apart from the main magnet; a flexible printed circuit (FPC) board electrically connected to the voice coil, including a first fixing portion fixed to the protrusion portion, a second fixing portion connected to the side surface portion, and a flexible arm connecting the first fixing portion and the second fixing portion.

The flexible arm and the main body are spaced apart along the vibration direction, the FPC board comprises a first FPC board and a second FPC board disposed on opposite sides of the auxiliary magnet, the first FPC board further comprises a bending portion adhered to the planar portion and facing a surface of the voice coil and a perpendicular portion connecting the second fixing portion and the bending portion, the bending portion comprises a solder pad electrically connected to the voice coil.

In addition, the frame is rectangular, the main body comprises two long axis sides oppositely disposed and two short axis sides connecting the long axis sides, the protrusion portion extends from an edge of the short axis sides and is integrally formed.

In addition, the auxiliary magnet comprises a first auxiliary magnet disposed on opposite sides of the main magnet along a long axis direction, the first auxiliary magnet comprises a side surface parallel to the vibration direction and away from the main magnet, the flexible arm is parallel to the side surface.

In addition, the auxiliary magnet further comprises a second auxiliary magnet disposed on opposite sides of the main magnet along a short axis direction, adjacent first auxiliary magnet and second auxiliary magnet are connected to each other, and a connection between the first auxiliary magnet and the second auxiliary magnet is at right angles.

In addition, the first FPC board further comprises an electrical connecting portion extending from the first fixing portion and away from the frame, the electrical connecting portion is configured to connect the voice coil with an external circuit.

In addition, the perpendicular portion and the voice coil are spaced apart in a direction perpendicular to the vibration direction.

In addition, the flexible arm comprises a first flexible arm connected to the first fixing portion, a second flexible arm connected to the second fixing portion, and an arcuate portion connecting the first flexible arm and the second flexible arm, the first flexible arm and the second flexible arm are parallel to each other.

In addition, the auxiliary magnet comprises an avoidance portion concaved from the side surface toward the main magnet, the second fixing portion and the avoidance portion are oppositely disposed along the vibration direction.

Compared with the related technology, the speaker provided by the present application comprises a frame having an accommodating space. The frame comprises a main body having an annular structure and a protrusion portion extending from the main body along the vibration direction and away from the diaphragm. The speaker further comprises a Flexible Printed Circuit (FPC) board electrically connected to the voice coil. The FPC board comprises a first fixing portion fixed to the protrusion portion, a second fixing portion connected to the diaphragm, and a flexible arm connecting the first fixing portion and the second fixing portion. The flexible arm and the main body are spaced apart along the vibration direction, which effectively reduces the space occupied by the FPC board in the frame, thereby increasing the volume of the magnetic circuit system and improving the acoustic performance of the speaker.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a speaker in accordance with an embodiment of the present application;

FIG. 2 is an exploded view of the speaker shown in FIG. 1;

FIG. 3 is a cross-sectional view of the speaker taken along line A-A in FIG. 1;

FIG. 4 illustrates an assembly of an FPC board, a diaphragm, a frame, and a voice coil of the speaker shown in FIG. 1;

FIG. 5 is an enlarged structural view of portion B in FIG. 4;

FIG. 6 is a structural view showing an assembly of the FPC board and frame of the speaker shown in FIG. 1;

FIG. 7 is a structural view of the speaker shown in FIG. 1 with a yoke thereof removed.

### DETAILED DESCRIPTION OF THE EMBODIMENTS

To further explain the embodiments, the present application provides drawings. These drawings form part of the disclosure of the present application and are mainly used to explain the embodiments and can be used to explain the operating principles of the embodiments in conjunction with the related descriptions in the specification. With reference to these contents, those skilled in the art should be able to understand other possible implementations and advantages of the present application. The components in the drawings are not drawn to scale, and similar component symbols are generally used to indicate similar components.

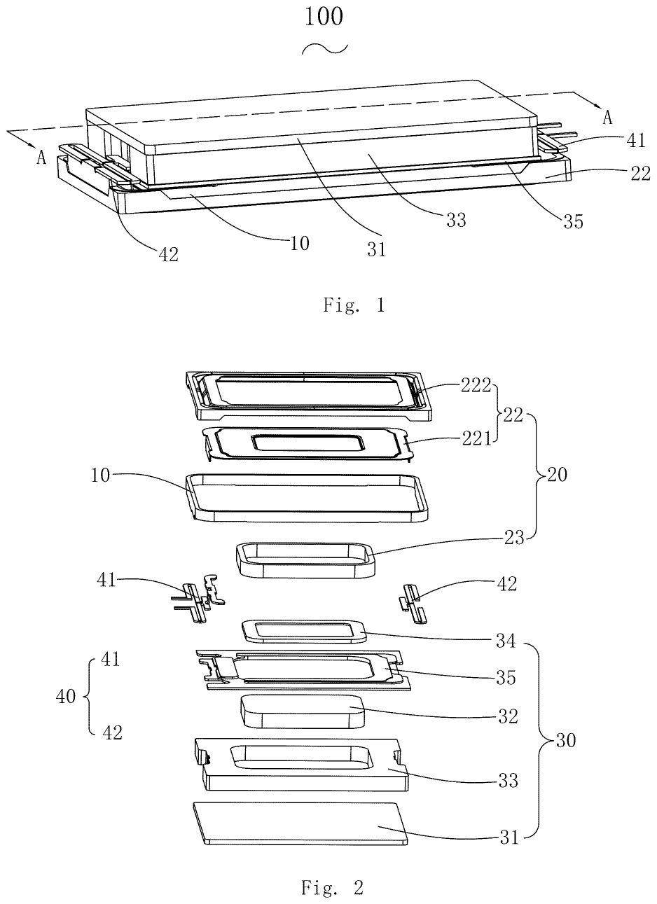

Referring to FIGS. 1 and 2, an embodiment of the present application provides a speaker 100, which comprises a frame 10 having an accommodating space, a vibration system 20 accommodated in the frame 10, a magnetic circuit system 30 driving the vibration system 20 to vibrate, and a Flexible Printed Circuit (FPC) board 40 for electrically connecting the speaker 100 to external circuits. The magnetic circuit system 30 and vibration system 20 are fixed to the frame 10, and the frame 10 can provide support for the magnetic circuit system 30 and vibration system 20.

Referring to FIGS. 1, 2, and 3, the vibration system 20 comprises a diaphragm 22 fixed to the frame 10 and a voice coil 23 driving the diaphragm 22 to vibrate and make sound. Electrical signals are introduced to the voice coil 23 through the FPC board 40. When the speaker 100 is connected to power, the voice coil 23 vibrates under the action of the magnetic circuit system 30, thereby driving the diaphragm 22 to vibrate and make sound.

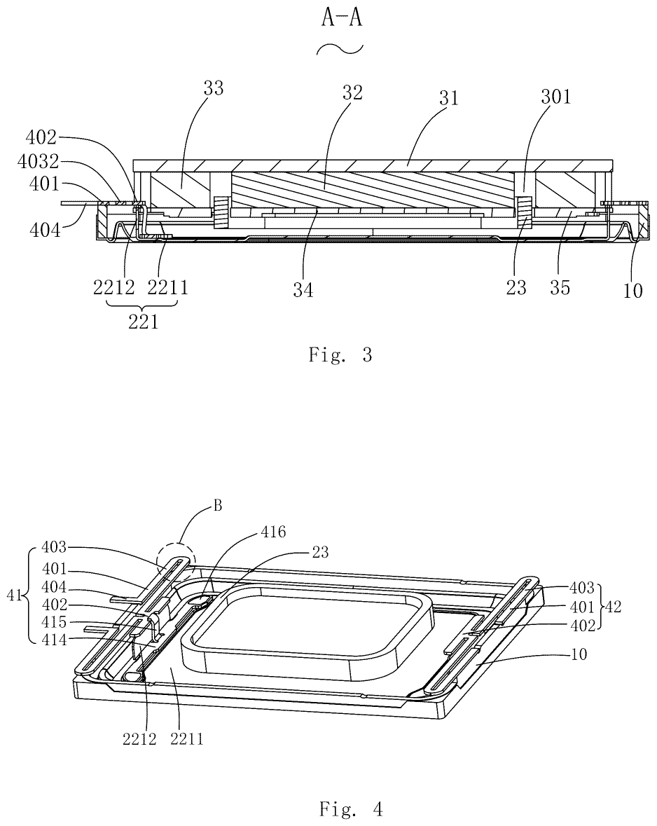

Referring to FIGS. 2 and 3, the magnetic circuit system 30 comprises a yoke 31 fixed to the frame 10, a main magnet 32 fixed to the yoke 31 on the side close to the vibration system 20, and an auxiliary magnet 33 spaced around the main magnet 32. The auxiliary magnet 33 and the main magnet 32 together form a magnetic gap 301, in which the voice coil 23 is suspended. The magnetic circuit system 30 also includes a main pole piece 34 located above the main magnet 32 and an auxiliary pole piece 35 located above the auxiliary magnet 33, with the auxiliary pole piece 35 fixed to the frame 10 to support the magnetic circuit system on the frame 10.

Referring to FIGS. 2 and 4, the diaphragm 22 comprises a dome 221 located at a middle position and a surround 222 spaced around the dome 221. The dome 221 comprises a planar portion 2211 perpendicular to the vibration direction and a side surface portion 2212 extending from an edge of the planar portion 2211 toward the magnetic circuit system 30.

Referring to FIGS. 4, 5, and 6, the frame 10 comprises a main body 11 having an annular structure and a protrusion portion 12 extending from the main body 11 along the vibration direction and away from the diaphragm 22. The frame 10 is rectangular, the main body 11 comprises two long axis sides 111 oppositely disposed and two short axis sides 112 connecting the long axis sides 111, the protrusion portion 12 extends from an edge of the short axis sides 112 and is integrally formed. The FPC board 40 comprises a first FPC board 41 and a second FPC board 42 disposed on opposite sides of the auxiliary magnet 33 along the long axis direction. The first FPC board 41 and the second FPC board 42 comprise a first fixing portion 401 fixed to the protrusion portion 12, a second fixing portion 402 connected to the side surface portion 2212, and a flexible arm 403 connecting the first fixing portion 401 and the second fixing portion 402. However, in the present application, the first FPC board 41 includes an electrical connecting portion 404 extending from the first fixing portion 401 and away from the frame 10, the electrical connecting portion 404 is configured to connect the voice coil 23 with external circuits. Meanwhile, the flexible arm 403 of the FPC board 40 and the main body 11 of the frame 10 are spaced apart along the vibration direction, which, compared with the prior art where the flexible arm needs to extend into the accommodating space of the frame, effectively reduces the space occupied by the FPC board 40 in the frame 10, thereby increasing the volume of the magnetic circuit system 30 and improving the acoustic performance of the speaker 100.

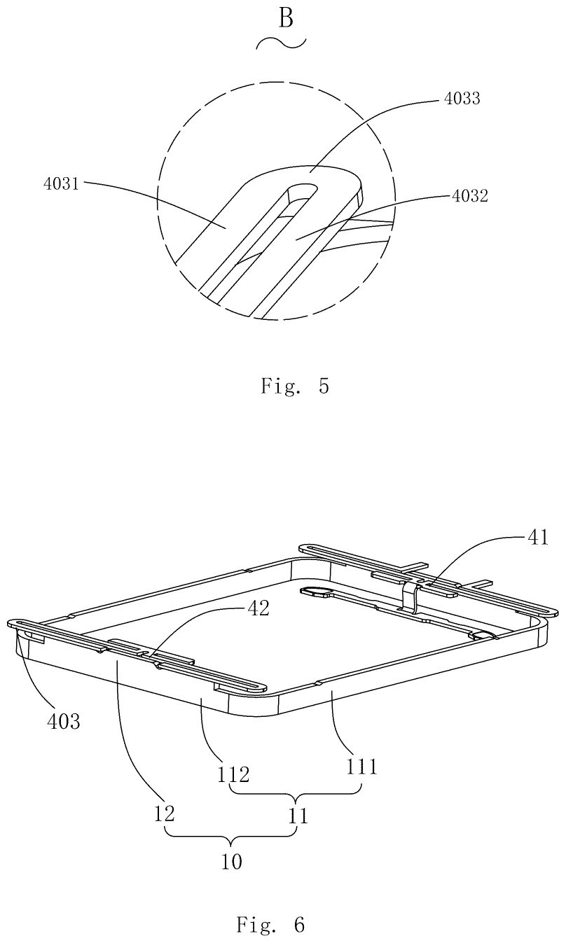

Referring to FIGS. 4 and 5, the flexible arm 403 comprises a first flexible arm 4031 connected to the first fixing portion 401, a second flexible arm 4032 connected to the second fixing portion 402, and an arcuate portion 4033 connecting the first flexible arm 4031 and the second flexible arm 4032, the first flexible arm 4031 and the second flexible arm 4032 are parallel to each other. Additionally, the first FPC board 41 further comprises a bending portion 414 adhered to the planar portion 2211 and facing a surface of the voice coil 23, and a perpendicular portion 415 connecting the second fixing portion 402 and the bending portion 414, wherein the perpendicular portion 415 and the voice coil 23 are spaced apart in a direction perpendicular to the vibration direction. The bending portion 414 comprises a solder pad 416 electrically connected to the voice coil 23.

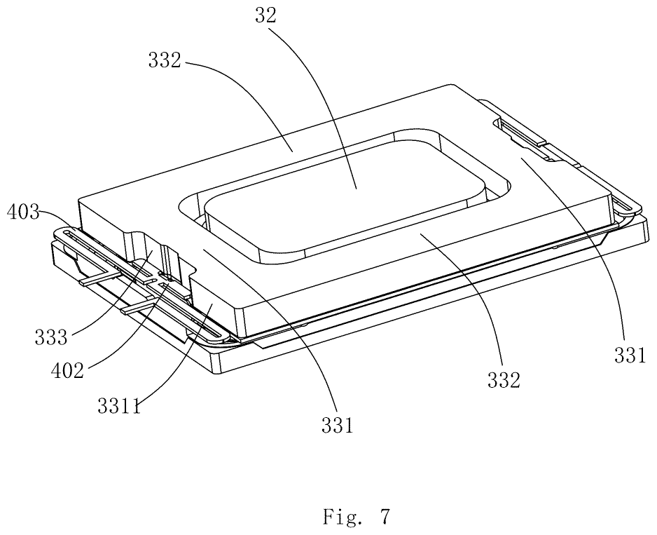

Referring to FIGS. 2 and 7, the auxiliary magnet 33 comprises a first auxiliary magnet 331 disposed on opposite sides of the main magnet 32 along the long axis direction. The first auxiliary magnet 331 comprises a side surface 3311 parallel to the vibration direction and away from the main magnet 32. Specifically, the flexible arm 403 is parallel to the side surface 3311. The auxiliary magnet 33 comprises an avoidance portion 333 concaved from the side surface 3311 toward the main magnet 32, wherein the second fixing portion 402 of the FPC board 40 and the avoidance portion 333 are oppositely disposed along the vibration direction, preventing collision between the FPC board 40 and the main magnet 32 during vibration. Meanwhile, the auxiliary magnet 33 further comprises a second auxiliary magnet 332 disposed on opposite sides of the main magnet 32 along the short axis direction. Adjacent first auxiliary magnet 331 and second auxiliary magnet 332 are connected to each other, and the connection between the first auxiliary magnet 331 and the second auxiliary magnet 332 is at right angles, effectively increasing the volume of the auxiliary magnet 33 and thereby improving the magnetic conductivity performance of the magnetic circuit system 30.

Compared with the prior art where the solder pad of the speaker's FPC board is fixed to the frame causing the flexible arm to bend and extend into the accommodating space of the frame, the flexible arm 403 of the speaker 100 of the present application and the main body 11 of the frame 10 are spaced apart along the vibration direction, effectively increasing the volume of the magnetic circuit system 30 in the accommodating space of the frame 10, thereby improving the acoustic performance of the speaker 100.

The foregoing is merely illustrative of embodiments of the present invention, and it should be noted that modifications may be made to those skilled in the art without departing from the spirit of the invention but are intended to be within the scope of the inventio.

What is claimed is:

1. A speaker, comprising:
a frame having an accommodating space;
a vibration system accommodated in the frame, including a diaphragm fixed to the frame and a voice coil driving the diaphragm to vibrate and make sound, the diaphragm having a dome located at a middle position and a surround spaced around the dome, the dome including a planar portion perpendicular to a vibration direction and a side surface portion extending from an edge of the planar portion, the frame including a main body having an annular structure and a protrusion portion extending from the main body along the vibration direction and away from the diaphragm;
a magnetic circuit system driving the vibration system to vibrate, including a yoke fixed to the frame, a main magnet fixed to the yoke, and an auxiliary magnet spaced apart from the main magnet;
a flexible printed circuit (FPC) board electrically connected to the voice coil, including a first fixing portion fixed to the protrusion portion, a second fixing portion connected to the side surface portion, and a flexible arm connecting the first fixing portion and the second fixing portion; wherein
the flexible arm and the main body are spaced apart along the vibration direction, the FPC board comprises a first FPC board and a second FPC board disposed on opposite sides of the auxiliary magnet, the first FPC board further comprises a bending portion adhered to the planar portion and facing a surface of the voice coil and a perpendicular portion connecting the second fixing portion and the bending portion, the bending portion comprises a solder pad electrically connected to the voice coil.

2. The speaker as described in claim 1, wherein the frame is rectangular, the main body comprises two long axis sides oppositely disposed and two short axis sides connecting the long axis sides, the protrusion portion extends from an edge of the short axis sides and is integrally formed.

3. The speaker as described in claim 1, wherein the auxiliary magnet comprises a first auxiliary magnet disposed on opposite sides of the main magnet along a long axis direction, the first auxiliary magnet comprises a side surface parallel to the vibration direction and away from the main magnet, the flexible arm is parallel to the side surface.

4. The speaker as described in claim 3, wherein the auxiliary magnet further comprises a second auxiliary magnet disposed on opposite sides of the main magnet along a short axis direction, adjacent first auxiliary magnet and second auxiliary magnet are connected to each other, and a connection between the first auxiliary magnet and the second auxiliary magnet is at right angles.

5. The speaker as described in claim 1, wherein the first FPC board further comprises an electrical connecting portion extending from the first fixing portion and away from the frame, the electrical connecting portion is configured to connect the voice coil with an external circuit.

6. The speaker as described in claim 1, wherein the perpendicular portion and the voice coil are spaced apart in a direction perpendicular to the vibration direction.

7. The speaker as described in claim 1, wherein the flexible arm comprises a first flexible arm connected to the first fixing portion, a second flexible arm connected to the second fixing portion, and an arcuate portion connecting the first flexible arm and the second flexible arm, the first flexible arm and the second flexible arm are parallel to each other.

8. The speaker as described in claim 3, wherein the auxiliary magnet comprises an avoidance portion concaved from the side surface toward the main magnet, the second fixing portion and the avoidance portion are oppositely disposed along the vibration direction.
